(19) United States
(12) Patent Application Publication
(10) Pub. No.: US 2024/0127515 A1
(43) Pub. Date: Apr. 18, 2024

(54) METHOD FOR DISPLAYING PAGE

(71) Applicant: STUDIO LAB CO., LTD, Seoul (KR)

(72) Inventors: Sung Hoon KANG, Seoul (KR); Jae Young LEE, Seongnam-si (KR); Dae Jung KIM, Anyang-si (KR)

(73) Assignee: STUDIO LAB CO., LTD, Seoul (KR)

(21) Appl. No.: 18/380,631

(22) Filed: Oct. 16, 2023

Related U.S. Application Data
(63) Continuation of application No. PCT/KR2023/015538, filed on Oct. 10, 2023.

(30) Foreign Application Priority Data
Oct. 12, 2022 (KR) 10-2022-0130234

(51) Int. Cl. G06T 11/60; G06F 40/40; G06V 10/44

(52) U.S. Cl. CPC G06T 11/60; G06F 40/40; G06V 10/44

(57) ABSTRACT

A method for displaying a page includes: acquiring a plurality of images; extracting features of the plurality of images; generating text based on the features of the plurality of images; and generating the page based on the features of the plurality of images, in which the page includes the plurality of images.

### TECHNICAL FIELD

The present disclosure relates to a method for displaying a page.

### BACKGROUND ART

When selling a product through a website, a merchandiser (MD) writes sentences that can well describe products, a designer generates a design that matches the products and the sentences, and a photographer and a designer edit and retouch photos to help products stand out.

When a product page was completed in this way, if a product seller's management ordered the page to be modified, the MD, the designer, and the photographer should edit the page again, which was inconvenient.

In addition, product pages produced in this way are displayed equally to all users, making it impossible to know the user's situation or intention. Therefore, methods for catching users who leave without purchasing the products are being discussed.

### DISCLOSURE

### Technical Problem

An embodiment provides a method for displaying a page to generate an optimal page for a seller.

An embodiment provides a method for displaying a page to generate an optimal page for a purchaser.

### Technical Solution

In an aspect of the present disclosure, a method for displaying a page includes: acquiring a plurality of images; extracting features of the plurality of images; generating text based on the features of the plurality of images; and generating the page based on the features of the plurality of images, in which the page may include the plurality of images.

The extracting of features of the plurality of images may include extracting common features of the plurality of images.

The generating of the page based on the features of the plurality of images may include editing the plurality of images based on the common features.

The generating of the text based on the features of the plurality of images may include; acquiring trend information; and generating the text based on the trend information and the features of the plurality of images, and the acquiring of the trend information may include acquiring the trend information from at least one of a sentence describing a product, a word, an adjective, a sentence included in an image, utterance contents of video content, a graphics interchange format (GIF), and a meme.

The generating of the page based on the features of the plurality of images may include generating a design based on the features of the plurality of images, and the design may include at least one of form, layout, and color in which the plurality of images are arranged.

The generating of the page based on the features of the plurality of images may include generating text associated with the plurality of images based on the features of the plurality of images.

The generating of the page based on the features of the plurality of images may include editing at least one of the plurality of images based on the features of the plurality of images.

The generating of the page based on the features of the plurality of images may include arranging the plurality of images based on the features of the plurality of images.

The arranging of the plurality of images may include arranging the plurality of images based on a proportion of a subject in the plurality of images.

The arranging of the plurality of images may include arranging the plurality of images based on a viewing angle in the plurality of images.

The arranging of the plurality of images may include arranging the plurality of images based on image types of the plurality of images.

In another aspect of the present disclosure, a method for displaying a page includes: acquiring user information; acquiring environmental information; acquiring existing page information of a user; receiving a user request; and generating the page based on the user request, the user information, the environment information, and the existing page information.

The user information may include at least one of personal information, purchase history, search history, access country, used language, and an access device, the environmental information may include at least one of season, time of the year, time, and day of the week, and the existing page information may include at least one of design, atmosphere, and color.

The generating of the page may include: acquiring text and an image according to the user request; and arranging the text and the image based on the user information and the environment information.

### Advantageous Effects

According to a method for displaying a page of an embodiment, it is possible for a seller selling a product to easily generate and correct pages.

According to a method for displaying a page of an embodiment, it is possible to increase a frequency with which a product is exposed to a purchasers who purchase the product, and increase the probability of a purchase by extending the time a purchaser stays on a site by providing customized information according to the purchaser's purchase point and situation.

### BRIEF DESCRIPTION OF THE DRAWINGS

FIG. 1 is a schematic block diagram of an electronic system according to an embodiment.

FIG. 2 is a diagram for describing an operation of a controller according to an embodiment.

FIG. 3 is an example of an image input to the controller according to the embodiment.

FIG. 4 is an example of an optimal page output by the controller according to the embodiment.

FIG. 5 is an example of an edit page output by the controller according to the embodiment.

FIG. 6 is an example of the edit page output by the controller according to the embodiment.

FIG. 7 is a flowchart of a method for displaying a page according to an embodiment.

FIG. 8 is a flowchart of the method for displaying a page according to the embodiment.

FIG. 9 is a flowchart of the method for displaying a page according to the embodiment.

FIG. 10 is a diagram for describing the operation of the controller according to the embodiment.

FIG. 11 is a flowchart of the method for displaying a page according to the embodiment.

FIG. 12 is a flowchart of a method for collecting trend information according to an embodiment.

FIG. 13 is a flowchart of a method for collecting trend information according to an embodiment.

### BEST MODE

Hereinafter, embodiments of the present disclosure will be described in detail with reference to the accompanying drawings so that those skilled in the art to which the present disclosure pertains may easily practice the present disclosure. However, the present disclosure may be implemented in various different forms, and is not limited to embodiments described herein.

In addition, in the drawings, portions unrelated to the description will be omitted to clearly describe the present disclosure, and similar portions will be denoted by similar reference numerals throughout the specification. In flowcharts described with reference to the drawings, an order of operations may be changed, several operations may be merged, some operations may be divided, and specific operations may not be performed.

In addition, an expression written in singular may be construed in singular or plural unless an explicit expression such as “one” or “single” is used. Terms including ordinal numbers such as “first,” “second,” and the like, may be used to describe various components. However, these components are not limited by these terms. These terms may be used to differentiate one component from other components.

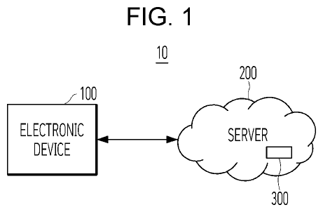

FIG. 1 is a schematic block diagram of an electronic system according to an embodiment.

Referring to FIG. 1, an electronic system 10 includes an electronic device 100 and a server 200. In the electronic system 10, the electronic device 100 and the server 200 may communicate with each other. The server 200 may provide services to a plurality of tenants. The server 200 may manage the plurality of tenants as customers. The plurality of tenants may each correspond to multiple users. For example, a first tenant among the plurality of tenants may access the server 200 using the electronic device 100 and use functions of the server 200.

The electronic device 100 may be a personal computer (PC), a portable electronic device, or the like, having a display. Here, the portable electronic devices may be implemented with a laptop computer, a mobile phone, a smart phone, a tablet PC, a mobile Internet device (MIDs), personal digital assistant (PDA), enterprise digital assistant (EDA), or a wearable device, etc. The wearable device may include a smart watch, a smart band, a smart glass, etc.

The electronic device 100 may communicate with the server 200 and use components of the server 200. For example, the components of the server 200 may include a controller 300, a network interface card (NIC), a storage device, etc.

The controller 300 may be implemented with an operation module such as a central processing unit (CPU), a graphics programming unit (GPU), a neural processing unit (NPU), or a tensor processing unit (TPU). The controller 300 may include an artificial intelligence (AI) model having an artificial neural network. The artificial intelligence model may be trained to generate optimal pages from input data. The input data may be data such as an image, user information, and environmental information. The optimal page may refer to a page where an image, text, a design, etc., are customized and optimized for a user. The controller 300 may train an artificial neural network using the input data and the generated optimal page as training data.

The NIC may include Ethernet NIC, remote direct memory access (RDMA) NIC, etc.

The storage device may include a solid state drive (SSD) device. For example, the SSD device may be a non-volatile memory express (NVM) SSD, etc.

The server 200 may communicate with the electronic device 100 using a network. The network may be a connection structure that allows information exchange between nodes such as devices and servers. For example, the network includes, but is not limited to, RF, a 3rd generation Partnership project (3GPP) network, a long term evolution (LTE) network, a 5th generation partnership project (5GPP) network, a world interoperability for microwave access (WIMAX) network, Internet, a local area network (LAN), a wireless local area network (Wireless LAN), a wide area network (WAN), a personal area network (PAN), a value added network (VAN), a Bluetooth network, an NFC network, a satellite broadcasting network, an analog broadcasting network, a digital multimedia broadcasting (DMB) network, or the like.

The controller 300 may receive images and/or information data from the electronic device 100. The image may include photos, videos, etc. The video may include continuous images taken by a camera and images generated by sticking together a plurality of discontinuous photos.

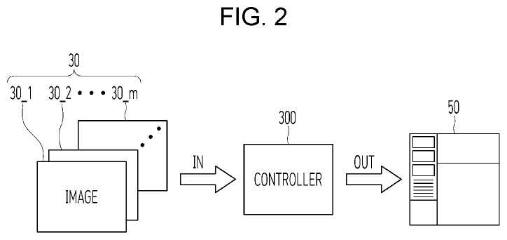

In an embodiment, when the controller 300 receives an image, the controller 300 may generate an optimal page by extracting features from the image, generating the design, generating text, and editing the image. The controller 300 may output the optimal page to the electronic device 100. The configuration in which the controller 300 generates the optimal page from the image will be described later with reference to FIGS. 2 to 9.

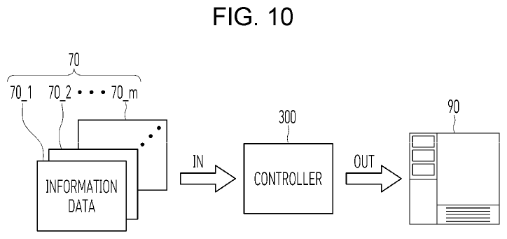

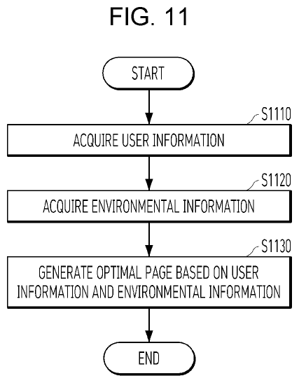

In an embodiment, when the controller 300 receives information data, the controller 300 may generate the optimal page based on the information data. For example, the information data may include user information and/or environmental information. According to the embodiment, the user information and/or environment information may be stored in a database (DB). The controller 300 may output the optimal page to the electronic device 100. The configuration in which the controller 300 generates the optimal page from the information data will be described later with reference to FIGS. 10 to 11.

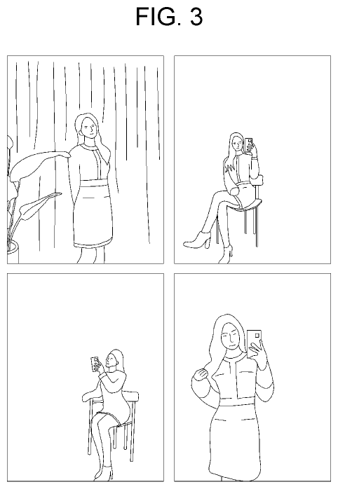

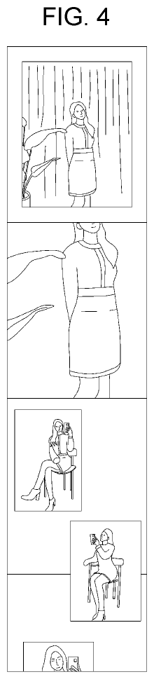

FIG. 2 is a diagram for describing an operation of a controller according to an embodiment, FIG. 3 is an example of an image input to the controller according to the embodiment, and FIG. 4 is an example of the optimal page output by the controller according to the embodiment.

Referring to FIG. 2, the controller 300 may receive a plurality of images 30. The plurality of images 30 may include first to mth images 30_1 to 30_m. Here, M may be an integer number greater than 1. In an embodiment, the image received by the controller 300 may be as illustrated in FIG. 3. In this case, m may be 4. The controller 300 may receive four images of FIG. 3 regardless of order.

The controller 300 may analyze the plurality of images 30. That is, the controller 300 may extract features of each of the plurality of images 30. For example, the controller 300 may extract a feature point of the first image 30_1, extract a feature point of the second image 30_2, . . . , extract a feature point of the mth image 30_m.

The controller 300 may extract common features of the plurality of images 30. For example, the controller 300 may determine attributes that the feature points extracted from the first to mth images 30_1 to 30_m commonly include. The controller 300 may determine a photo type defining the plurality of images 30 from the common attributes.

In an embodiment, the controller 300 may determine, from the common feature points of the first to m images 30_1 to 30_m, that the first to m images 30_1 to 30_m are photos of products (accessories, clothing, props, etc.) worn. In this case, the first to mth images 30_1 to 30_m may all include the same or similar products. Similar products may refer to products that have the same shape but different colors or sizes or the like.

In an embodiment, the controller 300 may determine, from the common feature points of the first to m images 30_1 to 30_m, that the first to m images 30_1 to 30_m are ID photos. In this case, all the first to mth images 30_1 to 30_m may only target human faces.

In an embodiment, the controller 300 may determine, from the common feature points of the first to m images 30_1 to 30_m, that the first to m images 30_1 to 30_m are natural photos. In this case, in the first to m images (30_1 to 30_m), the background such as sea, mountains, forests, and sky, occupies most of the images, and the proportion of people may be less than or equal to a certain ratio.

According to an embodiment, the controller 300 may output the determined photo type to the electronic device 100 and receive a response from the electronic device 100. The response may be yes or no. The controller 300 may update an artificial intelligence model based on the response from the electronic device 100, the plurality of images 30, and the determined photo type.

When the plurality of images 30 do not contain common attributes and are individual images with no relationship, the controller 300 may classify the plurality of images 30 based on the feature points of each of the plurality of images 30.

The controller 300 may edit the plurality of images 30 based on the feature points of each of the plurality of images 30. The editing may include adjusting image attributes such as luminosity, brightness, and saturation; inserting an image filter; inserting a frame; adding effects such as blur and mosaic; partial correction (distortion) such as reducing a face and lengthening legs, and enlarging eyes; cropping an image; removing shadows; removing background; zooming in/zooming out; adding text; attaching an image, etc.

For example, when the controller 300 determines that the plurality of images 30 are photos of a product being worn, the controller 300 may edit the plurality of images 30 so that an area occupied by a product in the plurality of images 30 exceeds a predetermined ratio. That is, the controller 300 may edit an image in which the area occupied by the product is less than or equal to a predetermined ratio. In an embodiment, when the predetermined ratio is 10% and the area occupied by the product in the first image 30_1 is 7%, the controller 300 may remove unnecessary parts from the first image 30_1 and enlarge the image so that the area occupied by the product exceeds 10%.

The controller 300 may determine a background portion of the image as an unnecessary portion. For example, the controller 300 may distinguish between human and non-human areas in an image and determine the non-human area as an unnecessary part. However, it is not necessarily limited thereto, and when the image is a natural photo, etc., the controller 300 may be implemented by determining that the human area is an unnecessary part.

The controller 300 may add text based on the feature points of each of the plurality of images 30. For example, the text may include clothing descriptions, sales phrases, etc. The controller 300 may add text according to the classified image. For example, in the case of an image of a person wearing a pink onepiece, the controller 300 may add text such as “Shalalala pink onepiece” to the image description.

The controller 300 may generate a design based on the feature points of each of the plurality of images 30. For example, the design may include shaping, layout, color, etc., in which the plurality of images 30 are arranged. The controller 300 may determine and output background colors based on color tones of the plurality of images 30. When the plurality of images 30 are images of a pink onepiece, the controller 300 may determine the background color to be a pink tone and output the pink tone.

The controller 300 may arrange the plurality of images 30 based on the extracted feature points. For example, the controller 300 may arrange the plurality of images 30 based on a proportion of a subject in the image.

In an embodiment, the controller 300 may arrange the plurality of images 30 in order (in ascending order) of increasing the proportion of the subject. In other words, a user may confirm an image in which a subject becomes increasingly zoomed out as a page is scrolled down. For example, the controller 300 may arrange the plurality of images 30 in ascending order in the case of the photo of the product being worn.

In an embodiment, the controller 300 may arrange the plurality of images 30 in order (in descending order) of decreasing the proportion of the subject. In other words, a user may confirm an image in which a subject becomes increasingly zoomed out as a page is scrolled down. For example, when the plurality of images 30 include different numbers of people, the controller 300 may arrange the plurality of images 30 in the order in which the number of people gradually increases. In other words, a proportion of one person in an image may gradually decrease.

In addition, the controller 300 may arrange the plurality of images 30 based on a viewing angle in an image.

In an embodiment, the controller 300 may arrange the plurality of images 30 in order of the viewing angle from top to bottom.

In an embodiment, the controller 300 may arrange the plurality of images 30 in the order in which the viewing angle moves from left to right. However, it is not necessarily limited thereto, and the controller 300 may arrange the plurality of images 30 in different directions.

In addition, when the plurality of images 30 include images of different types, the controller 300 may arrange the plurality of images 30 based on the image type. For example, the first to m−1th images 30_1 to 30_m−1 among the plurality of images 30 may be photos, and the mth image 30_m may be a video. The controller 300 may preferentially arrange the first to m−1th images 30_1 to 30_m−1 and arrange the mth image last. Alternatively, the controller 300 may preferentially arrange the mth image.

The controller 300 may adjust colors of each of the plurality of images 30 based on the extracted feature points. For example, the controller 300 may correct the plurality of images 30 with a color tone that includes the most common colors among the colors included in each of the plurality of images 30. When the plurality of images 30 primarily include blue color in common, the controller 300 may correct the plurality of images 30 in a way that emphasizes blue color.

The controller 300 may generate an optimal page 50 from the plurality of images 30. In an embodiment, the optimal page generated by the controller 300 using the image of FIG. 3 may be as illustrated in FIG. 4.

When generating the optimal page 50, the controller 300 may acquire and arrange data associated with the plurality of images 30. Data may be text, images, sound, etc. In this case, the controller 300 may use a crawling function. The crawling function may refer to a function of collecting websites, hyperlinks, data, information resources, etc. The controller 300 may assign an identifier to each collected data and store the data in a database.

Optionally, the controller 300 may acquire the image information from the electronic device 100. The electronic device 100 may input image information along with the plurality of images 30. For example, the electronic device 100 may inform the controller 300 that the plurality of images 30 are the photos of the product being worn while transmitting the plurality of images 30 to the controller 300. Accordingly, the controller 300 may acquire the product-related data from the database and arrange the data along with the plurality of images 30.

For example, when the second image 30_2 is an image of a pink onepiece, the controller 300 may acquire data about the product from the database. The controller 300 may acquire zoomed-in photos (neckline, accessories, finishing, etc.) of a pink onepiece, fabric photos, blend information, a washing method, a size, a thickness, fit, photos of different compositions, wearing photos of other users, and keywords searched together, related search words, etc., in the database.

The controller 300 may determine the compositions of the plurality of images 30 and acquire a photo with a composition that is not present in the plurality of images 30. For example, when the plurality of images 30 include only product images, the controller 300 may acquire a model wearing image, an actual user wearing image, etc., and arrange the acquired model wearing image, actual user wearing image, etc., along with the plurality of images 30. When the plurality of images 30 are partial images, the controller 300 may acquire a full image and arrange the acquired full image along with the plurality of images 30.

The controller 300 may arrange the acquired data along with the second image 30_2. For example, the controller 300 may arrange text such as “ShaLaLa onepiece” or “cherry blossom viewing onepiece” along with the second image 30_2, and arrange a pink tone image such as a cherry blossom image in the background.

In addition, when the third image 30 3 is an image related to a winter jumper, the controller 300 may arrange text such as “midwinter coat,” and “stove padding,” along with the third image 30 3, arrange an animated image of snow falling in the background, and output the effect of duck feathers spewing out.

The controller 300 may perform training using a plurality of images 30 and the generated optimal page 50 as the training data. The controller 300 may update the artificial intelligence model according to the training results.

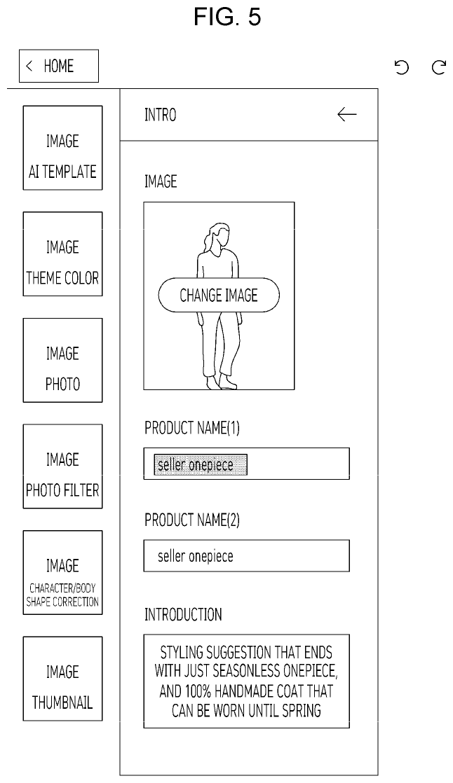

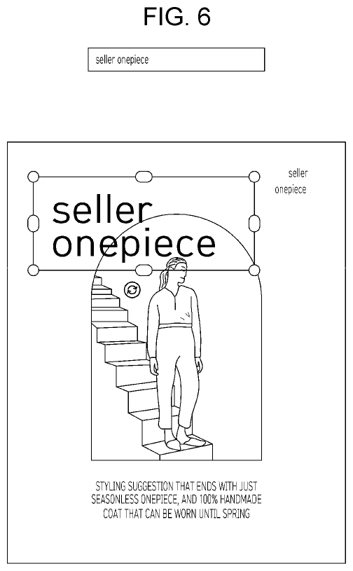

FIG. 5 is an example of an edit page output by the controller according to the embodiment, and FIG. 6 is an example of the edit page output by the controller according to the embodiment.

Referring to FIGS. 5 and 6, the controller 300 may provide an interface to the electronic device 100 so that the generated optimal page 50 may be modified. The interface may include menus such as AI templates, theme colors, photos, photo filters, portrait/body shape correction, and thumbnails. Accordingly, the user may easily modify the optimal page 50. The controller 300 may perform auxiliary operations when a user modifies the optimal page 50.

The user may not like styles (feminine, romantic, etc.) recommended by the controller 300. In this case, the controller 300 may receive a change request from the electronic device 100, and the controller 300 may recommend different templates. The user may change the entire design of the optimal page 50 with one click using the electronic device 100.

The controller 300 may receive a request to modify a product name and an introduction from the electronic device 100. Based on the request, the controller 300 may recommend matching product names and keywords or sentences that are easily exposed on the search platform. When a user does not like the sentences recommended by the controller 300, the user may recommend the entire sentence again. The controller 300 may also recommend the size, style, arrangement, etc., of the product name and introduction.

A user may wish to change a position of an image on the optimal page 50. That is, the controller 300 may request to change a position of an image from the electronic device 100. The controller 300 may determine the user's intention and also change an arrangement of other photos. For example, the controller 300 may receive images of products in two colors A and B. When the electronic device 100 moves B before A, the contents of the entire text and the position of the image may change based on B.

The controller 300 may receive keywords from the electronic device 100. The keywords may be keywords related to the product name or the introduction. The controller 300 may recommend text that matches the keywords. For example, when the controller 300 receives the keyword ‘sleeveless’ from the electronic device 100, the controller 300 may output text such as “sleeveless to wear coolly in the summer.” The electronic device 100 may use the text output by the controller 300 as it is, may modify the text, or may not use the text.

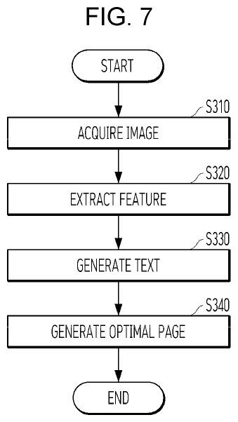

FIG. 7 is a flowchart of the method for displaying a page according to the embodiment.

Referring to FIG. 7, the method for displaying a page according to an embodiment may be performed by the electronic device. The method for displaying a page according to an embodiment may output a page for a seller. The electronic device may perform machine learning, including the artificial intelligence model. The electronic device may be a controller included in the server.

The electronic device may acquire an image (S310). The image may include photos, videos, etc. The video may include continuous images taken by a camera and images generated by sticking together a plurality of discontinuous photos. The electronic device may receive a plurality of images. In this case, the plurality of images may be related to each other, or may be individual images that are not related to each other.

The electronic device may extract the features of the image (S320). The electronic device may analyze the image and extract the features of the image. For example, the electronic device may extract the feature points of the image and determine the photo type of the image. The photo type may be an ID photo, a product photo, a nature photo, etc.

The electronic device may generate text (S330). The electronic device may generate text based on the features and trend information of the image. That is, the electronic device may acquire the trend information. The electronic device may acquire the trend information from at least one of a sentence describing a product, a word, an adjective, a sentence included in an image, utterance contents of video content, a graphics interchange format (GIF), and a meme. For example, when the phrase “Let's go on a vacation!” is a recent trend, and the image acquired in step S310 is an image of “sleeveless,” the electronic device may generate the text “Let's go on a vacation with sleeveless that may be worn coolly in the summer”, and may arrange the text near the image.

Text may be generated in one or more languages, and generated in two or more languages at the same time, there allowing the language to vary depending on user information or access country.

When there are a plurality of images, the electronic device may extract common features of the plurality of images. Based on the common features, the electronic device may perform operations such as determining that the plurality of images include a common product or determining that the plurality of images are all ID photos.

The electronic device may generate an optimal page including an image (S340). The electronic device may generate the optimal page based on the features of the image. For example, the electronic device may perform at least one operation of design generation, text generation, image editing, and image arrangement based on the features of the image. The electronic device may provide the generated optimal page to the user.

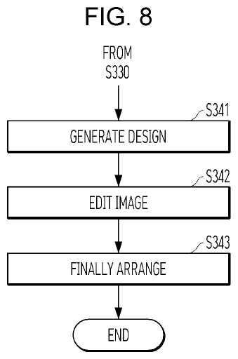

FIG. 8 is a flowchart of the method for displaying a page according to the embodiment.

Referring to FIG. 8, the electronic device according to an embodiment may generate text (S330) and then generate a design (S341). For example, the design may include shaping, layout, color, etc. When the electronic device receives a plurality of images, the electronic device can determine attributes that the plurality of images have in common from the extracted features. The electronic device may generate a design based on common attributes of a plurality of images.

The electronic device may edit an image (S342). The editing may include adjusting image properties such as luminosity, brightness, and saturation; inserting an image filter; inserting a frame; adding effects such as blur and mosaic; partial correction (distortion) such as reducing a face and lengthening legs, and enlarging eyes; cropping an image; removing shadows; removing background; zooming in/zooming out; adding text; attaching an image, etc. When the plurality of images are images of the same product, the electronic device may edit the image so that the ratio of the product occupied in the image exceeds a predetermined ratio.

The electronic device may finally arrange images (S343). The electronic device may arrange images according to the features of the plurality of images. For example, the electronic device may arrange a plurality of images based on a proportion of a subject. The electronic device may arrange a plurality of images based on a viewing angle. The electronic device may arrange a plurality of images according to an image type.

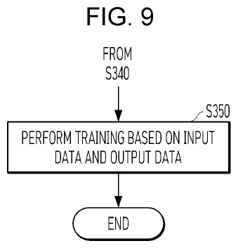

FIG. 9 is a flowchart of the method for displaying a page according to the embodiment.

Referring to FIG. 9, after generating the optimal page (S340), the electronic device according to an embodiment may perform training based on input data and output data (S350). The electronic device may update an artificial intelligence model. When the plurality of images are received later, the electronic device may generate the optimal page using the updated artificial intelligence model.

FIG. 10 is a diagram for describing the operation of the controller according to the embodiment.

Referring to FIG. 10, the controller 300 may receive a plurality of pieces of information data 70. The plurality of pieces of information data 70 may include first to nth information data 70_1 to 70_n. Here, n may be an integer number greater than 1. The information data 70_1 to 70_n may include user information and/or environmental information and/or user's existing sales page information. According to an embodiment, the user information and/or environment information and/or user's existing sales page information may be stored in the database.

The user information may include personal information such as gender and age, information on purchase history, search history, access country, access device, used language, etc. The user information may be stored in the electronic device as log data.

The environmental information may include information on the time series environment, such as season (S/S, F/F, etc.), time of the year, time, and day of the week.

The user's existing sales page information may include information on brand concept of the site, such as design, atmosphere, and color of a detail page, and other information paired with the detail page. Other information paired with the detail page may include thumbnails, display advertisements, offline advertisements, short-form videos, etc. The information may be stored in the electronic device as the log data.

The controller 300 may analyze the plurality of pieces of information data 70. That is, the controller 300 may extract features of each of the plurality of pieces of information data 70. For example, the controller 300 may extract a feature point of first information data 70_1, extract a feature point of second information data 70_2, . . . , extract a feature point of nth information data 70_n.

The controller 300 may generate an optimal page 90 based on the extracted features. The optimal page 90 may be a page that responds to a user request. That is, the controller 300 may generate the optimal page 90 so that a page includes information optimized for user information and/or environmental information while outputting a page corresponding to a user request.

The controller 300 has a method for generating the optimal page 90 in real time, and may classify a user group into two or more groups based on user information, generate a page suitable for each group in advance, and then generate pages suitable for each user group in advance.

For example, a first user may access the server 200 using a first electronic device. The first user may search for ‘wedding guest coordination’ on the server 200. In this case, the controller 300 of the server 200 may determine a wedding guest look with a neat and unobtrusive color and design based on the user information and/or environmental information of the first user and recommend the determined wedding guest look to the first user. In this case, the controller 300 may output text such as “I recommend a wedding guest look with neat and unobtrusive color and design” to the first user. When the current time of the year is summer, a short-sleeved onepiece in a neat and calm color may be recommended to the first user.

The second user may access the server 200 using the second electronic device. The second user may search for ‘date look’ on the server 200. In this case, the controller 300 may determine onepiece that gives a neat date look and an innocent feeling based on the user information and/or environmental information of the second user and recommend the determined onepiece to the second user. In this case, the controller 300 may output text such as “This is onepiece that gives an innocent feeling with a neat date look” to the second user. Even for the same product, the controller 300 may output different text depending on the user's purpose, etc. The method for outputting, by the controller 300, text is not limited to formats such as voice, image, or text.

The controller 300 may output information that a user may be interested in based on the plurality of pieces of information data 70. The information that the user may be interested in may include products that are sold a lot to users similar to a user on a shopping site, products similar to products searched by the user, etc.

The controller 300 may output text in one or more languages according to language used by a user based on the plurality of pieces of information data 70.

In an embodiment, the controller 300 may determine that a user is a woman in her 10s or 20s as a result of analyzing the plurality of pieces of information data 70. The controller 300 may arrange a short-form video at the top of the page. The controller 300 may reduce the number of texts and move a female fitting photo to the top. The controller 300 may design a page using shaping, layout, and color that match the color and type of women's clothing.

In an embodiment, the controller 300 may determine that a user is a man in his 40s or 50s as a result of analyzing the plurality of pieces of information data 70. The controller 300 may zoom-in the size of text and images and increase the number of texts. The controller 300 may move a male fitting photo to the top. The controller 300 may design a page using shaping, layout, and color that match the color and type of man's clothing.

The controller 300 may provide the optimal page 90 to the user. The controller 300 may train an artificial intelligence model using at least one of user information, environment information, and optimal pages.

FIG. 11 is a flowchart of the method for displaying a page according to the embodiment.

Referring to FIG. 11, the method for displaying a page according to an embodiment may be performed by the electronic device. The method for displaying a page according to an embodiment may output a page for a purchaser. The electronic device may perform machine learning, including the artificial intelligence model. The electronic device may be a controller included in the server.

The electronic device may acquire user information (S1110).

The user information may include personal information such as gender and age, information on purchase history, search history, access country, access device, etc. The user information may be stored in the electronic device as the log data.

The electronic device may acquire environmental information (S1120).

The environmental information may include information on the time series environment, such as season (S/S, F/F, etc.), time of the year, time, and day of the week.

The electronic device may generate an optimal page based on the user information and the environment information (S1130). The optimal page may be a page that responds to a user request. That is, the electronic device may generate a page so that a page includes information optimized for user information and/or environmental information while outputting a page corresponding to a user request.

The electronic device may acquire text and images according to user requests and arrange the text and images based on the user information and the environment information.

For example, the electronic device may output information that a user may be interested in to a page. The information that the user may be interested in may include products that are sold a lot to users similar to a user on a shopping site, products similar to products searched by the user, etc.

The electronic device may train an artificial intelligence model using at least one of the user information, the environment information, and the optimal page as training data.

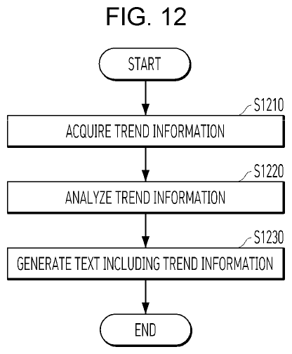

FIG. 12 is a flowchart of a method for collecting trend according to an embodiment.

Referring to FIG. 12, the method for collecting trend according to an embodiment may be performed by the electronic device. The electronic device may perform machine learning, including the artificial intelligence model. The electronic device may be a controller included in the server.

The electronic device may acquire the trend information (S1210).

The trend information may include information on meme, funny GIF, video, etc. The user information may be stored in the electronic device as the log data. For example, as a representative funny GIF, a resignation funny GIF quoting a scene from the cartoon Inuyasha may be stored in an electronic device as the log data.

The electronic device may acquire the trend information (S1220). The collected trend information is analyzed and classified and analyzed so that it may be used to generate a page. For example, information that may cause social controversy or moral issues may be removed, and usable information may be classified and stored.

The electronic device may generate text that reflects the trend (S1230).

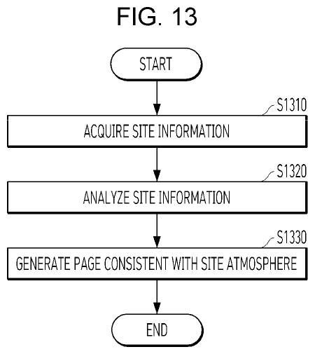

FIG. 13 is a flowchart of a method for collecting user's existing sales page information according to an embodiment.

Referring to FIG. 13, a method for collecting request site information according to one embodiment may be performed by the electronic device. The electronic device may perform machine learning, including the artificial intelligence model. The electronic device may be a controller included in the server.

The electronic device may acquire the user's existing sales page information (S1310).

The sales page information may include information on the design, atmosphere, color, etc., of the existing detail page and other information paired with the detail page. The sales page information may be stored in an electronic device as the log data.

The electronic device may analyze the sales page information (S1320). The electronic device may analyze the collected request site information and classifies and analyzes the collected request site information so that it may be used to generate the page.

The electronic device may generate a page consistent with the site atmosphere based on the analyzed page information (S1330). For example, when colors of a detailed page posted on the existing request site are composed of white and black, the electronic device mainly uses white and black to generate the page to maintain a sense of unity with the existing detailed page.

In some embodiments, each component or combination of two or more components described with reference to FIGS. 1 to 13 may be implemented with a digital circuit, a programmable or non-programmable logic device or array, or an application specific integrated circuit (ASIC), etc.

Although embodiments of the present disclosure have been described in detail hereinabove, the scope of the present disclosure is not limited thereto, but may include several modifications and alterations made by those skilled in the art using a basic concept of the present disclosure as defined in the claims.

### MODE FOR INVENTION

Modes for carrying out the invention have been described together in the best mode for carrying out the invention above.

### INDUSTRIAL APPLICABILITY

The present disclosure relates to a method for displaying a page, and has repeatability and industrial applicability in an electronic system for displaying content on web pages, etc.

1. A method for displaying a page, comprising:
acquiring a plurality of images;
extracting features of the plurality of images;
generating text based on the features of the plurality of images; and
generating the page based on the features of the plurality of images,
wherein the page includes the plurality of images.

2. The method for claim 1, wherein the extracting of features of the plurality of images includes extracting common features of the plurality of images.

3. The method for claim 2, wherein the generating of the page based on the features of the plurality of images includes editing the plurality of images based on the common features.

4. The method for claim 1, wherein the generating of the text based on the features of the plurality of images includes;
acquiring trend information; and
generating the text based on the trend information and the features of the plurality of images, and
the acquiring of the trend information includes acquiring the trend information from at least one of a sentence describing a product, a word, an adjective, a sentence included in an image, utterance contents of video content, a graphics interchange format (GIF), and a meme.

5. The method for claim 1, wherein the generating of the page based on the features of the plurality of images includes generating a design based on the features of the plurality of images, and
the design includes at least one of form, layout, and color in which the plurality of images are arranged.

6. The method for claim 1, wherein the generating of the page based on the features of the plurality of images includes generating text associated with the plurality of images based on the features of the plurality of images.

7. The method for claim 1, wherein the generating of the page based on the features of the plurality of images includes editing at least one of the plurality of images based on the features of the plurality of images.

8. The method for claim 1, wherein the generating of the page based on the features of the plurality of images includes arranging the plurality of images based on the features of the plurality of images.

9. The method for claim 8, wherein the arranging of the plurality of images includes arranging the plurality of images based on a proportion of a subject in the plurality of images.

10. The method for claim 8, wherein the arranging of the plurality of images includes arranging the plurality of images based on a viewing angle in the plurality of images.

11. The method for claim 8, wherein the arranging of the plurality of images includes arranging the plurality of images based on image types of the plurality of images.

12. A method for displaying a page, comprising:
acquiring user information;
acquiring environmental information;
acquiring existing page information of a user;
receiving a user request; and
generating the page based on the user request, the user information, the environment information, and the existing page information.

13. The method for claim 12, wherein the user information includes at least one of personal information, purchase history, search history, access country, used language, and an access device,
the environmental information includes at least one of season, time of the year, time, and day of the week, and
the existing page information includes at least one of design, atmosphere, and color.

14. The method for claim 12, wherein the generating of the page includes:
acquiring text and an image according to the user request; and
arranging the text and the image based on the user information and the environment information.
